(19) United States
(12) Patent Application Publication
(10) Pub. No.: US 2010/0208231 A1
(43) Pub. Date: Aug. 19, 2010

(54) LIGHT WAVE DISTANCE MEASURING SYSTEM AND DISTANCE MEASURING DEVICE

(76) Inventor: Hiromichi Murai, Chofu-Shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/531,403

(22) PCT Filed: Mar. 14, 2008
(86) PCT No.: PCT/JP2008/054813

§ 371 Date: Apr. 12, 2010

(30) Foreign Application Priority Data
Mar. 15, 2007 (JP) 2007 066803

(51) Int. Cl. G01C 3/08

(52) U.S. Cl. 356/4.01

(57) ABSTRACT

Object is to provide a light wave distance measuring system and a light wave distance measuring device which are capable of realizing prolonged measurable distance as well as improved distance measuring accuracy and which enable a distance measuring device to be constructed inexpensively.

A light wave code-modulated with a first PN code is transmitted to a target to be distance-measured, and a second PN code which has the same sequence as that of the first PN code but which has a frequency slightly different from that of the first PN code, and a correlation value between the first PN code and the second PN code is converted into a waveform signal having a low frequency, and the light wave reflected from the target to be distance-measured is received by a light receiving element to which the second PN code is applied, and the received light wave is converted into a waveform signal having a low frequency, and a phase difference between the transmitting side correlation signal and the receiving side correlation signal is determined, and a distance to the target to be distance-measured is calculated from the phase difference.

### TECHNICAL FIELD

The present invention relates to a light wave distance measuring system and a distance measuring device which use a light wave code-modulated with a PN code, for example, an M-sequence PN code or the like.

### BACKGROUND ART

Conventional distance measuring systems are roughly classified into the following four basic systems.

1. Trigonometric Ranging System

This system has been put to practical use in the form of a low price distance measuring sensor. However, this system has insufficient distance measuring accuracy due to its principle, and since it is not capable of long distance measurement, it cannot be applied to the subject device of the present application.

2. Time of Flight (TOF) Ranging System

A TOF ranging system transmits short light pulses to an object to be distance-measured, receives the pulses reflected from the object, and measures round-trip flight time to thereby determine a distance.

However, since this system directly depends on speed of light, it is not suitable for measurement of a short distance or applications which require high resolution. For example, in order to obtain resolution of 15 mm, it is required to measure a flight time with a clock of 10 GHz.

Further, in this case, since it is required to process pulses of about 50 ps, the system is greatly influenced by waveform of the pulses. Waveform of pulses reflected from an object at a short distance and that of pulses reflected from an object at a long distance are greatly different from each other. Accordingly, it is difficult to determine a threshold value. Design of a linear amplifier with a large dynamic range capable of covering such short pulses is difficult, and thus it is difficult to attain high resolution of distance measurement.

There has also been realized a system which is capable of indirectly measuring time without using a high clock frequency by virtue of its time expansion function. However, the measurement requires a prolonged period of time, and distortion of waveform due to the time expansion still remains as a problem, and it is thus difficult to realize high resolution.

3. Phase Difference Ranging System

A phase difference ranging system is a system which is capable of realizing high resolution. In order to realize a high resolution, however, stable reflected light is required which is, for example, reflected light having stable intensity and less noise. Accordingly, it is necessary to perform measurement while subjecting a received light signal to averaging a number of times to increase a signal-to-noise ratio. On account of this, the time required for the measurement is increased, and measurement objects are restricted only to substantially static objects.

4. PN Ranging System

With respect to a ranging system using pseudorandom number signals, basic principle is disclosed in Patent Document 1.

In this system, ranging is carried out by intensity-modulating light with a code sequence having good autocorrelation properties such as M sequence or Gold sequence, transmitting the intensity-modulated light, and receiving the light reflected from the target, followed by correlation processing.

According to this system, the problems in the phase difference ranging system are overcome. In other words, this system has features that it does not necessarily require stable reflected light and that it has high resolution and is less susceptible to influences of external noises.

Patent Document 1: Japanese Unexamined Patent Publication No.2002-055158

### DISCLOSURE OF INVENTION

### Problem to be Solved by the Invention

A correlation processing method in a PN ranging system which is disclosed in Patent Document 1 is such that, as shown in FIG. 8, light is detected by a light receiving element 31 such as an APD and amplified, and then correlation processing is carried out by a correlator (2) 32. In this connection, the same frequency component as intensity-modulated frequency of the light is outputted from the light receiving element 31 and led to the correlator (2) 32.

In this system, however, the pathway in which the frequency component is led to the correlator (2) 32 makes a factor that renders phase error in the intensity-modulated frequency greater.

In other words, the method disclosed in Patent Document 1 has disadvantages in the following points when the modulated light wave is detected and the modulated frequency is outputted by the light receiving element 31.

(1) When high-resolution measurement is carried out, intensity modulation is effected generally with a signal frequency of several hundred MHz.

The signal detected and outputted by the light receiving element 31 necessarily has the intensity-modulated frequency. Accordingly, it is necessary to carry out operation in the subsequent stage of from the amplifier 33 to the correlator (2) 32 at the frequency. In general, a surface by which a light wave is reflected is diffuse-reflective, and thus received optical signal is extremely weak and should be supposed to be about several nW. From such faint light, it is difficult to amplify the optical signal of several hundred MHz in the subsequent amplification stage by means of the amplifier 33 without changing phase of the signal.

(2) Since distance information is obtained in the form of phase information, the phase should be prevented from undergoing change even by any change in conditions of the circuit such as a change in temperature, supply voltage or the like.

It is, however, difficult to stabilize the phase at several hundred MHz.

In view of the above-described problems inherent in the conventional techniques, it is an object of the present invention to provide a light wave distance measuring system and a light wave distance measuring device which are capable of realizing prolonged measurable distance as well as improved distance measuring accuracy and which enable a distance measuring device to be constructed inexpensively.

### MEANS TO SOLVE THE PROBLEMS

Accordingly, the distance measuring system of the present invention for solving the above-described problems comprises (1) a means for transmitting a light wave code-modulated with a first PN code to a target to be distance-measured; (2) a means for receiving the light wave reflected by the target to be distance-measured; (3) a means for generating a second PN code which has the same sequence as that of the first PN code but which has a frequency slightly different from that of the first PN code; (4) a means for generating a transmitting side correlation signal based on a correlation value between the first PN code and the second PN code; (5) a means for generating a receiving side correlation signal based on the received light wave to which the second PN code has been applied; and (6) a means for determining a phase difference between the transmitting side correlation signal and the receiving side correlation signal to calculate a distance to the target to be distance-measured based on the phase difference.

The distance measuring system may further comprise a means for integrating the received light wave to which the second PN code has been applied.

The delay time in the form of the phase difference between the transmitting side correlation signal and the receiving side correlation signal may be measured by a separate measuring system which is independent of a standard oscillator.

Further, the distance measuring device of the present invention comprises (1) a first PN code generator for generating a first PN code; (2) a transmitter for transmitting a light wave code-modulated with the code outputted from the first PN code generator to a target to be distance-measured; (3) a light receiving element for receiving the light wave reflected from the target to be distance-measured; (4) a second PN code generator for generating a second PN code which has the same sequence as that of the first PN code but which has a frequency slightly different from that of the first PN code; and (5) a phase difference determining means for determining phase difference between the transmitting side correlation signal which is a correlation signal between the first PN code generated by the first PN code generator and the second PN code and the receiving side correlation signal which is generated by applying the second PN code from the second PN code generator to the light receiving element and which is outputted from the light receiving element.

The distance measuring device may further comprise an integration circuit for integrating the receiving side correlation signal which is generated by applying the second PN code from the second PN code generator to the light receiving element and which is outputted from the light receiving element.

The distance measuring device may be such that the first PN code generator is driven by a frequency generated by a standard oscillator to generate the first PN code, and the second PN code generator is driven by a frequency which is generated by a reference oscillator and which is slightly different from that generated by the standard oscillator to generate the code having the same sequence as that of the first PN code generated by the first PN code generator.

A signal which is generated by superimposing the second PN code from the second PN code generator on a direct voltage from a bias circuit on in a super imposing circuit may be applied to the light receiving element.

The delay time in the form of the phase difference between the transmitting side correlation signal and the receiving side correlation signal may be measured by a beat-down counter.

### EFFECT OF THE INVENTION

As described above, according to the light wave distance measuring system and the light wave distance measuring device of the present invention, a light wave code-modulated with PN code is used, and it is thereby not required in high-resolution and high-accuracy distance measurement that the modulated frequency (several ten MHz to 1 GHz) of the light is selected from the light receiving element and processed in the subsequent stage of the circuit, and in general, it is only required to process a correlation signal of a low-frequency component of about several KHz. By virtue of this, phase fluctuation caused by change in conditions of the circuit such as change in temperature, power supply voltage or the like can be reduced to enable improvement of distance measurement accuracy to be realized.

Further, since light reflected from the target is very weak, a transimpedance circuit is generally used as a circuit for efficiently converting minute electric current generated by the faint light into a voltage signal with low noise. However, a transimpedance circuit which operates at a high frequency of several hundred MHz is not an ordinary one, and upper limit of frequency at which an ordinary transimpedance circuit operates is about several ten MHz. It is difficult in a circuit which operates at such a frequency to realize low noise, and if such a circuit were produced, it is expensive. According to the present invention, however, since it is only required to process a signal having frequency of about several KHz, a low-noise and inexpensive transimpedance circuit can be constructed. Further, by virtue of the fact that the noise is low, more faint light can be received to enable measurable distance to be prolonged.

### BEST MODE FOR CARRYING OUT THE INVENTION

Best mode for carrying out the present invention will be described below with reference to the drawings.

FIG. 1 is a block diagram schematically showing an example of device configuration of the distance measuring device of the present invention.

Referring to FIG. 1, the distance measuring device of the present invention comprises a standard oscillator 1 for generating a predetermined frequency; a code generator (1) 2 for generating a PN code which is driven by the frequency generated by the standard oscillator 1 via a phase synchronizing circuit PLL (1); a transmitter 4 for receiving a light wave code-modulated with the code outputted from the code generator (1) 2 via a driver 3 and transmitting the light waves to a target 20 to be distance-measured; and a light receiving element 5 for receiving the light wave reflected from the target 20 to be distance-measured.

The distance measuring device of the present invention further comprises a code generator (2) 6, which is driven by the frequency generated by the standard oscillator 1 via a phase synchronizing circuit PLL (2), for generating a PN code having the same sequence as that of the code generated by the code generator (1) 2; a correlator 7 for determining a correlation value between the first PN code generated by the code generator (1) 2 and the second PN code generated by the code generator (2) 6 to generate a correlation signal; an integration circuit 8 for integrating a receiving side correlation signal that is generated by applying a signal into which a direct-current voltage from a bias circuit and the second PN code from the second PN code generator are synthesized in a superimposing circuit to the light receiving element and that is outputted from the light receiving element; and an information processor (not shown) for determining a distance to the target 20 to be distance-measured which has a phase sensitive detector 9 for determining a phase difference between a signal outputted by the correlator 7 and a signal outputted by the integration circuit 8.

FIGS. 2 and 3 show (FIG. 2 shows) in detail synchronized oscillators comprising the standard oscillator 1 and PLL (1) and the standard oscillator and PLL (2).

In FIG. 2, PLL (1) comprises a phase comparator 1-1, a low-pass filter LPF 1-2, a voltage-controlled oscillation circuit VCO1 which generates frequency that changes according to voltage, and a frequency divider (1) 1-3.

PLL (2) comprises a phase comparator 2-1, a low-pass filter LPF 2-2, a voltage-controlled oscillation circuit VCO2 which generates frequency that changes according to voltage, and a frequency divider (2) 2-3.

FIG. 3 shows principle of a technique called “beat-down” which indirectly measures propagation time by means of the standard oscillators 1, PLL(1) and 1, PLL (2). It is difficult, in a phase difference ranging system which measures a difference between arrival times of signals of electromagnetic wave such as light or electric wave to determine a distance, to directly measure the difference between arrival times of signals by a simple method.

For example, when a distance resolution of 1 [mm] is intended to be obtained, it is required in view of the round trip of the signal to measure a time period in which the signal propagates 2 [mm].

Since propagation speed of the electromagnetic wave signal in the atmosphere is about 3×10¹¹ [mm/s], the propagation time of 2 [mm] is 6.67 [ps](=2 [mm]/3×10¹¹ [mm/s]=6.67×10⁻¹² [s]). This requires a very high-speed and high-accuracy time measuring system. Such a time measuring system is likely to have drawbacks that it is very expensive, and that it consumes large electric power. Accordingly, in the distance measuring device of the present invention, a beat-down method as shown in FIG. 3 is employed.

In FIG. 3, DELAY represents a propagation time (φ)in which the signal arrives at the target to be distance-measured and the reflected signal returns to the system. MOD represents a modulated signal generator, which generates a signal S1(t) having a frequency of f1. LO represents a locally-generated signal generator necessary for beat-down, which generates a signal S2(t) having a frequency of f2. STD OSC represents a standard oscillator, STD represents a standard signal, DELAY represents a delay time according to a distance, each of Mixers 1 and 2 represents a multiplier, each LPF represents a low pass filter, and Vref represents a reference signal. DelayCN represents a delay time counter, and Vdelay represents a distance measurement signal.

Even if it is given that amplitude of each of the signal generators shown in FIG. 3 is 1, generality is maintained. Accordingly, S1(t) and S2(t) may be represented by the following formulae, respectively.

S1(t)=cos (2πf1t) (1)

S2(t)=cos (2πf2t) (2)

Then, output of the Mixer 1 is as follows.

S1(t)×S2(t)=cos (2πf1t)×cos (2πf2t)=(½)×[ cos 2π(f1+f2)t+cos 2π(f1 −f2)t] (3)

When the output of the Mixer 1 passes through the LPF (low pass filter), the first term of the right side of the formula (3) is not outputted.

In consequence, Vref is as follows.

Vref=cos {2π(f1−f2)t}/2 (4)

Since S(t) is inputted into the Mixer 2 after occurrence of the propagation delay φ, the output of the Mixer 2 is as follows.

S1(t+φ)×S2(t)=cos (2πf1 t+φ)×cos (2πf2t)=(½)×[cos {2π(f1+f2)t+φ}+cos {2π(f1−f2)t+φ}] (5)

When the output of the Mixer 2 passes through the LPF (low pass filter), the first term of the right side of the formula (5) is not outputted.

In consequence, Vdelay is as follows.

Vdelay=cos {2π(f1−f2)t+φ)}]/2 (6)

It is, therefore, understood that amount of delay at a frequency of (f1−f2) is the same as the delay time φ at a frequency of f1.

In other words, when f2is so selected as to be a frequency approximate to f1, (f1−f2) is a very low frequency. By virtue of this, the amount of delay time at f1 can be measured at a low frequency of (f1−f2).

For example, f1 and f2 are so selected that f1−f2 is approximately 10 [KHz].

If it is assumed that f1=800.00 [MHz] and f2=799.99 [MHz], f1−f2=10 [KHz].

In other words (As described above), measurement of the amount of propagation delay φ at a frequency of 800 [MHz] is equivalent to measurement of the amount of propagation delay φ at a frequency of 10 [KHz]. Accordingly, it is easier that beat-down is effected to perform measurement at a lower frequency.

In general, a beat-downed signal has its delay amount measured as a time period by means of a zero-crossing comparator, counter and the like, as shown in FIG. 4. From the measured propagation delay amount φ, a distance R is calculated.

R=c/2(1−f2/f1)φ (7)

What is described above is basic principle of distance measurement by beat-down method.

In this connection, with respect to an error due to deviation of each of frequencies, when the frequencies are synchronized with the same standard source, the f2/f1 is neglected and thus no error in distance measurement is caused.

In the next place, procedure of distance measurement using the distance measuring device shown in FIG. 1 will be described. The standard oscillator 1 generates a predetermined frequency to drive the code generator (1)2, and the code generator (1) 2 thereby generates a first PN code having the predetermined frequency. The first PN code is transmitted to the driver 3 and the correlator 7. The driver 3 generates a light wave code-modulated with the PN code, and the transmitter 4 transmits the light wave to the target 20 to be distance-measured.

The light wave is reflected by the target 20 to be distance-measured.

On the other hand, the code generator (2)6 generates a second PN code which has the same sequence as that of the first PN code but which has a frequency slightly different from that of the first PN code. The second PN code is transmitted to the superimposing circuit and superimposed on the voltage from the bias circuit and applied to the light receiving element 5.

The light receiving element 5, to which the second PN code superimposed on the voltage from the bias circuit has been applied from the superimposing circuit, receives the light wave reflected from the target 20 to be distance-measured. In this manner, the signal which is generated by superimposing the code signal from the code generator (2) on the voltage from the bias circuit in the superimposing circuit is applied to the light receiving element 5.

In the light receiving element 5, detection of the light and multiplication of the light signal by the code signal are performed by virtue of nonlinear characteristics. Since the light signal is modulated by the code generator (1), the multiplication is code-code multiplication.

FIG. 5 shows periodical relationship between the generated codes, and each of blocks in FIG. 5 represents one period of each of the codes. The codes are of the same sequence but have slightly different clock frequencies. Accordingly, the periods thereof have slightly different lengths, as shown in FIG. 5.

In this connection, although the block 1 and the block 1′ have bit lengths slightly different from each other, the bit lengths may be considered (deemed) to be substantially the same. Accordingly, result of multiplication of each bit of the first PN code by the corresponding bit of the second PN code (which are is assumed to be +1 or −1 for convenience) is 1. When the output is integrated in each of the periods by means of the integration circuit 8 shown in FIG. 1, the output profiles as shown in FIG. 6 which are proportional to number of coincidence of bits are obtained.

In the correlator 7 and the integration circuit 8, the correlation value between the first PN code and the second PN code and a correlation value between the PN code of the light wave reflected by the target 20 to be distance-measured and the second PN code are calculated, respectively. From the correlation values, respective correlation signals are generated.

In this connection, the transmitting side correlation signal outputted from the correlator 7 and the receiving side correlation signal outputted from the integration circuit 8 are signals in the form of burst signals in each of which a plurality of peak signals are present as shown in FIG. 6. By determining ΔT shown in FIG. 6, distance measurement value can be obtained.

Next, another embodiment of the distance measuring device of the present invention will be described.

When the beat-down method as shown in FIG. 3 is carried out, two oscillators synchronized with each other are employed, and beat-down or correlation processing is performed to generate a lower frequency component from modulated frequencies of light waves, thereby effecting time expansion to realize high resolution measurement.

However, synchronization accuracy between the two oscillators greatly influences degree of time expansion (magnification) and can contribute to error. Further, such oscillators are expensive, and this leads to cost increase. In other words, the synchronized oscillators comprising a standard oscillator 1, PLL(1) and the standard oscillator 1, PLL(2) are required, as shown in FIG. 2. Since the phase synchronizing circuits (PLL(1) and PLL(2)) synchronized with the same standard source are employed, the VCOs or the like is required, leading to increased cost.

Now then, as described above, when the distance R is calculated from the measured propagation delay amount φ,

R=c/2(1−f2/f1)φ=c/2((f1−f2)/f1)φ (7)

When f1−f2 is expressed as fBD (,i.e., f1−f2=fBD),

R=c/2((fBD)/f1)φ (8)

It is understood that if the fBD in the formula (8) is determined by measuring a period of a beat-downed signal in real time by means of an fBDCNT (beat-down counter) as a separate measurement system as shown in FIG. 7, the synchronized oscillators having the phase synchronizing circuits synchronized with the same standard source are not required.

As described above, in the previously described embodiment, the highly stable synchronized oscillator composed of (comprising) the standard oscillator, PLL(1) and PLL(2) is required, in particular, the voltage-controlled oscillators (VCOs) used in the oscillator are required, leading to the expensive structure. In this latter embodiment, however, it is not required to determine a phase absolute value in determination of a measured distance value, and it is possible to obtain the determined distance value by calculating phase ratio with a usual counter. By virtue of this, a distance measuring device can be constructed inexpensively.

### BRIEF DESCRIPTION OF DRAWINGS

FIG. 1 is a block diagram showing one device configuration of the distance measuring device as an embodiment of the present invention.

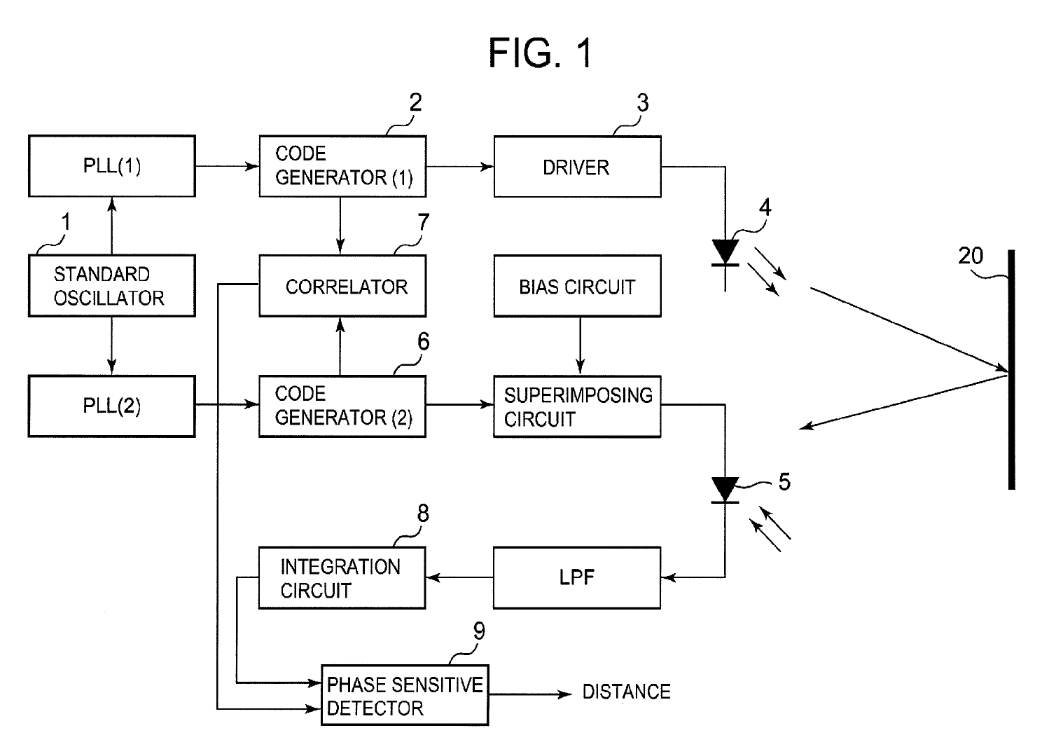

FIG. 2 is a block diagram showing in detail a synchronized oscillator in the device configuration of the distance measuring device shown in FIG. 1 as the embodiment of the present invention shown.

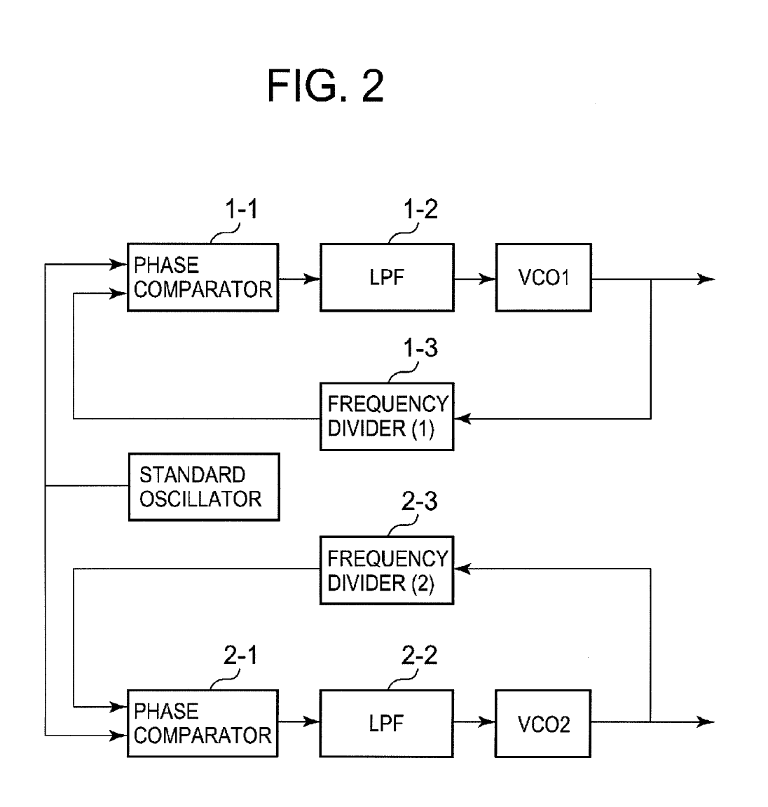

FIG. 3 is an illustrative view showing principle of a technique called beat-down.

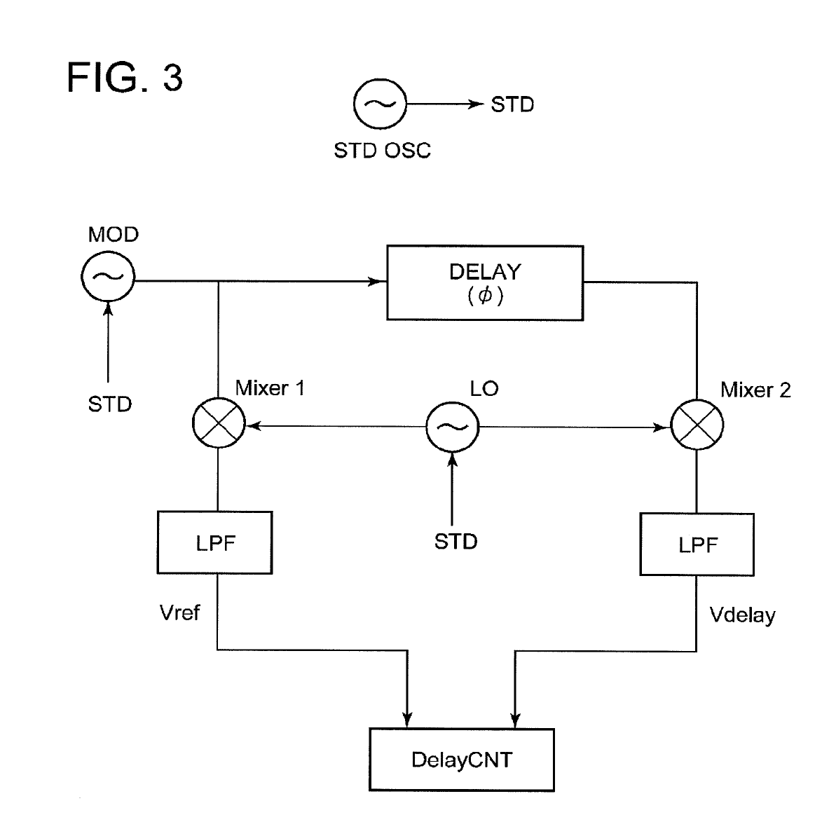

FIG. 4 is an illustrative view showing manner of calculating a distance R from a propagation delay amount φin the beat-down technique.

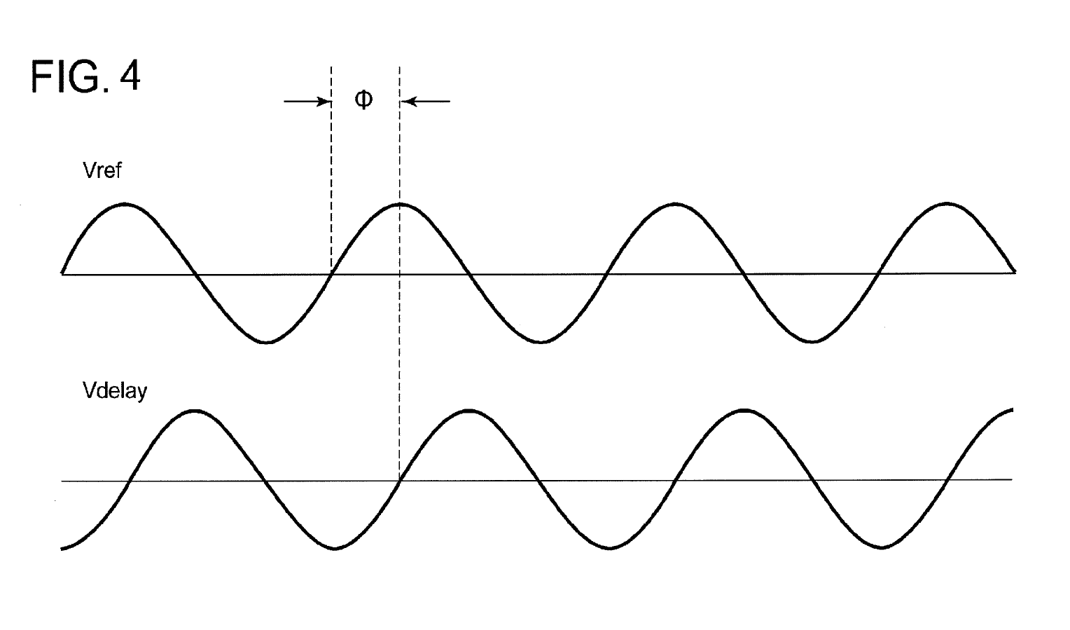

FIG. 5 is a schematic view showing periodical relationship between a transmitting side correlation signal and a receiving side correlation signal.

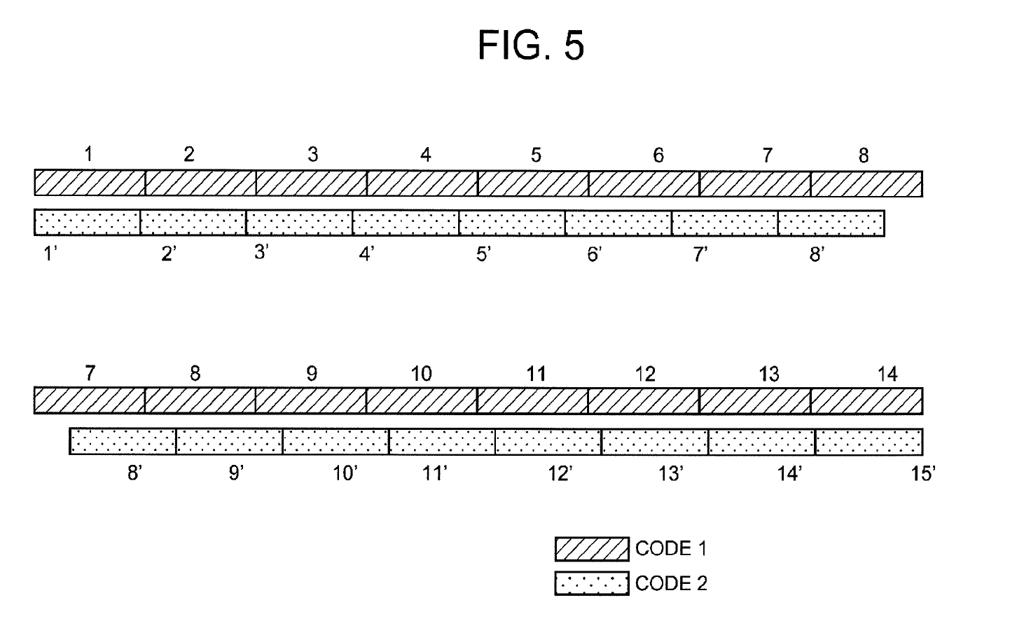

FIG. 6 is a schematic view of a transmitting side waveform signal and a receiving side waveform signal which are outputted from an integrator of the distance measuring device shown in FIG. 1 as the embodiment of the present invention.

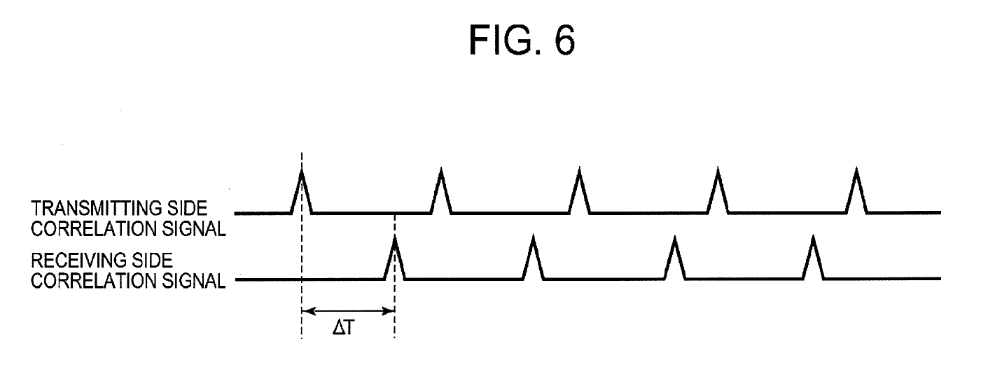

FIG. 7 is a block diagram showing a distance measuring device configuration as another embodiment of the present invention.

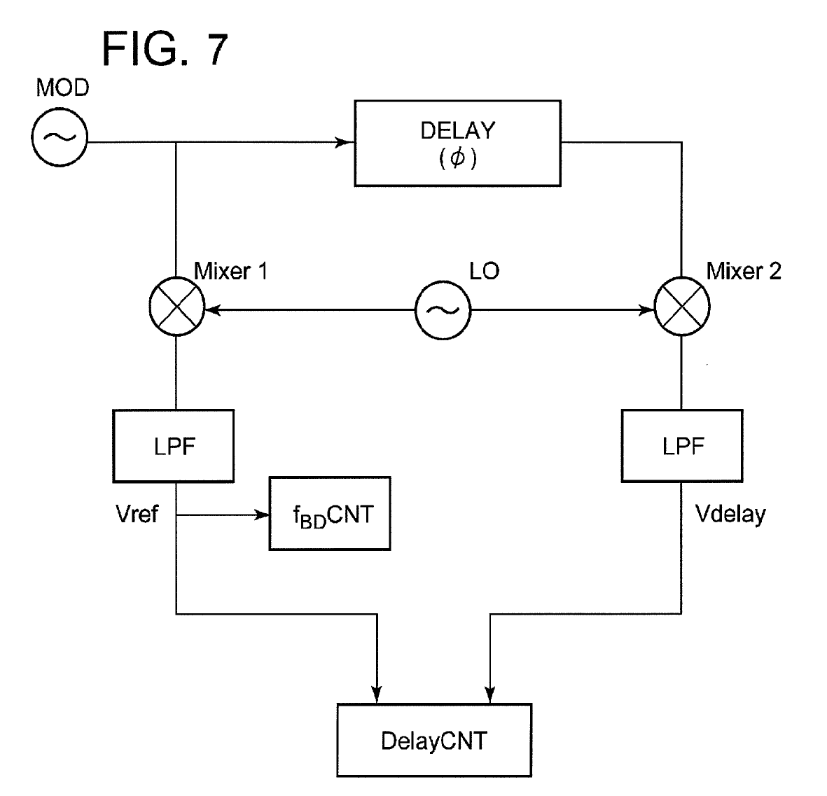

FIG. 8 is a block diagram showing basic principle of a conventional PN distance measurement system.

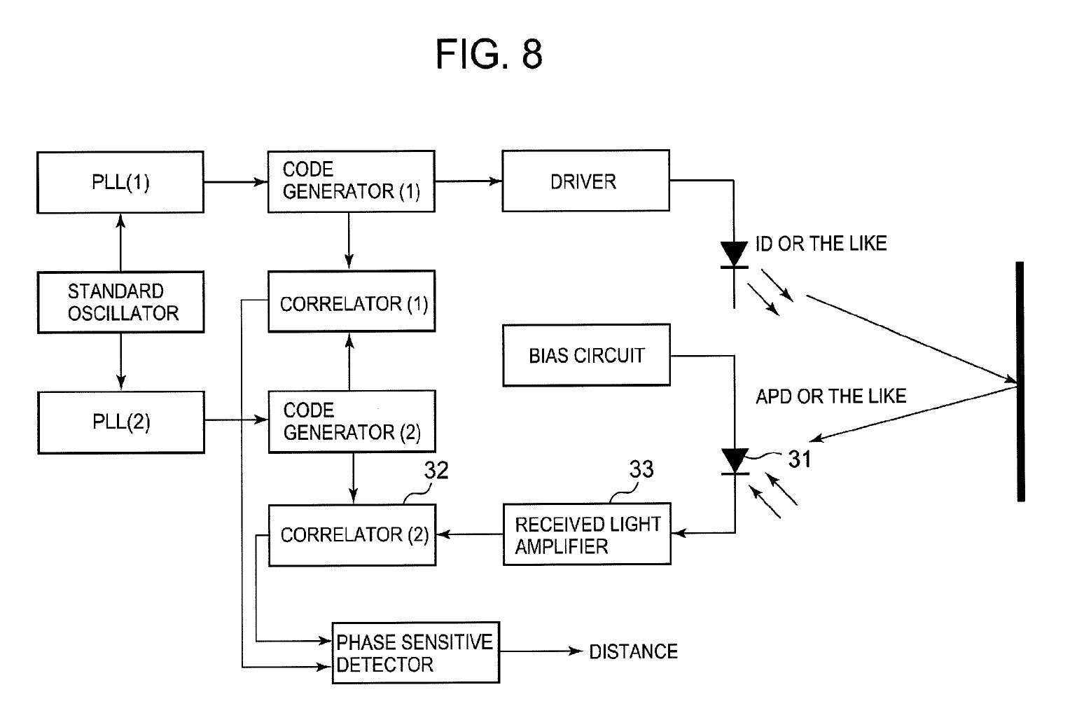

### NOTE ON REFERENCE NUMBERS

1 . . . standard oscillator, 1-1 and 2-1 . . . phase comparators, 1-2 and 2-2 . . . low pass filters (LPFs), 1-3 and 2-3 . . . frequency dividers (1) and (2), 2 . . . code generator (1), 3 . . . driver, 20 . . . target to be distance-measured, 4 . . . transmitter, 5 . . . light receiving element, 6 . . . code generator (2), 7 . . . correlator, 8 . . . integration circuit, 9 . . . phase sensitive detector

1. A distance measuring system comprising:
(1) a means for transmitting a light wave code-modulated with a first PN code to a target to be distance-measured;
(2) a means for receiving the light wave reflected by the target to be distance-measured;
(3) a means for generating a second PN code which has the same sequence as that of the first PN code but which has a frequency slightly different from that of the first PN code;
(4) a means for generating a transmitting side correlation signal based on a correlation value between the first PN code and the second PN code;
(5) a means for generating a receiving side correlation signal based on the received light wave to which the second PN code has been applied; and
(6) a means for determining a phase difference between the transmitting side correlation signal and the receiving side correlation signal to calculate a distance to the target to be distance-measured based on the phase difference.

2. The distance measuring system according to claim 1, further comprising a means for integrating the received light wave to which the second PN code has been applied.

3. The distance measuring system according to claim 1, wherein the delay time in the form of the phase difference between the transmitting side correlation signal and the receiving side correlation signal is measured by a separate measuring system which is independent of a standard oscillator.

4. A distance measuring device comprising:
(1) a first PN code generator for generating a first PN code;
(2) a transmitter for transmitting light wave code-modulated with code outputted from the first PN code generator to a target to be distance-measured;
(3) a light receiving element for receiving the light wave reflected from the target to be distance-measured;
(4) a second PN code generator for generating a second PN code which has the same sequence as that of the first PN code but which has a frequency slightly different from that of the first PN code; and
(5) a phase difference determining means for determining phase difference between the transmitting side correlation signal which is a correlation signal between the first PN code generated by the first PN code generator and the second PN code and the receiving side correlation signal which is generated by applying the second PN code from the second PN code generator to the light receiving element and which is outputted from the light receiving element.

5. The distance measuring device according to claim 4, further comprising an integration circuit for integrating the receiving side correlation signal which is generated by applying the second PN code from the second PN code generator to the light receiving element and which is outputted from the light receiving element.

6. The distance measuring device according to claim 4, wherein the first PN code generator is driven by a frequency generated by a standard oscillator to generate the first PN code, and the second PN code generator is driven by a frequency which is generated by a reference oscillator and which is slightly different from that generated by the standard oscillator to generate the code having the same sequence as that of the first PN code generated by the first PN code generator.

7. The distance measuring device according to claim 4, wherein a signal which is generated by superimposing the second PN code from the second PN code generator on a voltage from a bias circuit in a superimposing circuit is applied to the light receiving element.

8. The distance measuring device according to claim 4, wherein the delay time in the form of the phase difference between the transmitting side correlation signal and the receiving side correlation signal is measured by a beat-down counter.
